(19) United States
(12) Patent Application Publication
(10) Pub. No.: US 2005/0144034 A1
(43) Pub. Date: Jun. 30, 2005

(54) Injection molded footwear manufactufing system

(76) Inventor: Charles Phifer Hunter, Chesapeake, VA (US)

Correspondence Address: Charles P. Hunter, 2045 Iowa Street, Chesapeake, VA, 23323, US

(21) Appl. No.: 11/026,765

(22) Filed: Dec. 31, 2004

Related U.S. Application Data
(60) Provisional application No. 60/533,270, filed on Dec. 31, 2003.
(60) Provisional application No. 60/533,271, filed on Dec. 31, 2003.
(60) Provisional application No. 60/533,272, filed on Dec. 31, 2003.

(51) Int. Cl. G06F 17/60

(52) U.S. Cl. 705/1

(57) ABSTRACT

The invention provides a faster simpler method of manufacturing injected molded polyurethane footwear consisting of two or more parts with different compositions. The business practice of leasing this turnkey system and providing a full-time technician to administer the system allows for minimal investment by a business owner and yields the highest quality product. Simultaneously injecting two different formulas of polyurethane into two different cavities of the same mold will significantly cut production time and cost. The dual rotating or shuffling sole-plate makes it possible to inject the outsole and the insole/upper/shaft simultaneously without fear of mixing. Similarly other poly products consisting of,two or more parts may also be produced using this complex molding system. The unique multi-station linear molding table provides the necessary platform for these special complex molds and enables the changing of molds and/or service to the equipment without fully shutting down or halting all production.

### CROSS-REFERENCE TO RELATED APPLICATIONS

This application claims the benefit of provisional patent applications: Ser. No. 60/533,270 filed Dec. 31, 2003 by the present inventor Ser. No. 60/533,271 filed Dec. 31, 2003 by the present inventor Ser. No. 60/533,272 filed Dec. 31, 2003 by the present inventor

### FEDERALLY SPONSORED RESEARCH

Not Applicable

### SEQUENCE LISTING OR PROGRAM

Not Applicable

### BACKGROUND OF THE INVENTION

1. Field of the Invention

This invention relates to certain methods of manufacturing injection molded polyurethane products such as footwear, the types of equipment used, the types of molds used and the business practices used in the manufacturing process.

2. Prior Art

Over twelve billion pairs of footwear were produced worldwide last year. Six percent of the total produced or seven hundred million pairs are classified as protective footwear. Last year in the United States alone the footwear market exceeded one million two hundred thousand pairs, seventy million pairs of which were protective footwear. Rubber, PVC and Polyurethane boots are all classified as protective footwear whether worn by a child in the snow and rain or by a pig farmer tending his herd.

The manufacturing of Polyurethane products such as footwear has typically adhered to common methods of technical production and methods of business practice. Currently the cost of manufacturing Polyurethane boots for instance is significantly more than that of manufacturing boots made of PVC or rubber. Polyurethane boots are commonly accepted as a far superior product by end users. Longer life, better wear and greater comfort in various kinds of environments are some of the stated reasons end users prefer Polyurethane boots to those made of PVC or rubber. The increased cost to manufacture Polyurethane boots, as much as two or three times that of PVC or rubber, limits the number of persons and/or companies who can afford to purchase the superior Polyurethane boots.

Currently there are very few Polyurethane boots manufactured in the United States. Nearly all Polyurethane boots sold in the U.S. are imported and therefore are subject to a high tariff and import fees of as much as thirty seven percent or more which further increases the end retail cost of this product.

Therefore, a method to significantly reduce the manufacturing costs of Polyurethane boots would make them easier to produce domestically. Domestic production would eliminate the various import fees and thus significantly reduce the retail pricing of this product. These same high manufacturing costs are a substantial reason why Polyurethane boots are not manufactured in many other countries. Thus, a low cost method of manufacturing Polyurethane boots would effect the world wide market and result in the superior boot being made available to a much larger consumer group at an affordable price.

Manufacturers typically own or lease there injection molding equipment and manage it's operation with their own personnel. The technician operating the production equipment must be highly trained and preferably able to manufacture the products at the highest level of efficiency with little or no wasted time or raw materials. The cost of establishing a Polyurethane footwear manufacturing operation is typically substantial and may range from half a million to several million U.S. dollars depending on the scope of operations and production goals. The cost of a single injection molding machine can be as much as six hundred thousand U.S. dollars and more. The molding table and other equipment, administrative software, and training all add to the bottom line and increase the overall cost.

The purchase of the raw materials used in this equipment to produce the product is rarely if ever tied to the purchase of said equipment or tied to the use of specific equipment. Instead, the raw materials used to produce the product are typically selected based on price, availability and quality. Therefore, the manufacturer receives no benefits from using a particular type of injection molding equipment or system when it comes to the price they pay for raw materials. This is notable in that over the course of one year a single injection molding machine may use several hundred thousand U.S. dollars worth of raw materials in the production process.

Most footwear manufactures do so domestically in that their respective governments have specific protections for this industry. These would include high tariffs, duties, other fees and bans associated with the importing of various types of footwear products. Therefore, if a particular shoe design is highly desired by consumers in one country, a manufacturer in another who can not legally import the product may duplicate the design and manufacturer it for their domestic market. This process is very costly and involves research, development and a lot of time.

Governments of various countries have specific reasons for maintaining the domestic control of the footwear industry. By doing so they not only regulate imports but influence the domestic products their citizens will have to select from. This highly regulatory approach to footwear products provides both quality controls and economic controls effecting both the costs of manufacturing and the cost to consumers.

There is a significant cost for product research and design for items such as footwear. This expense is typically born by the manufacture who passes it on. The process may involve the study of markets worldwide to identify and develop products desired by specific consumer groups. This process is typically repeated by manufactures in different countries serving different consumer groups and markets thus the cost of R&D of the same product is duplicated several times and typically passed on to the consumer via a higher retail price.

The design, development and production of marketing materials for each specific product can be substantial and once again duplicated from one country to the next and each time the cost is typically passed on to the consumer via a higher retail price.

Existing technology and methods used in the manufacturing of Polyurethane boots and other protective footwear has several short comings when more than a single color and/or different materials are used for different parts of the same boot. For instance, when the outsole is to be black and have a more rigid texture and the insole/upper/shaft is to be a different color and have a softer texture the manufacturing process becomes lengthy. In this case first the outsole is molded first and before continuing must cure for a few minutes. Then the molds are separated and repositioned so the insole/upper/shaft can be injected. Once the insole/upper/shaft has been injected it to must set idle while it cures for a few minutes against the outsole before the finished boot can be removed from the mold.

The injection process takes only a few seconds but the curing process takes a few minutes and slows the entire process. In that the curing process must take place for each portion/section of the boot having a different color and/or consistency/texture, it can be very costly. The ability to inject all portions/sections of a boot or other product at the same time would significantly reduce the production time and overall cost of the product.

Multi-station injection molding tables and/or machines have more than a single pair of molds which are each injected on a cycle. Most often the molds are mounted on a round carousel. The number of molds may range from two to eighteen or more. Preferably a selection of molds with a number of different foot size's will make up the mix of molds on a multi station machine. Unfortunately, these machines are most often designed so that the molds move and the injection head remains stationary. This design thus requires the entire machine to be shut off and production stopped entirely when a pair of molds needs to be changed or when any other service needs to be preformed on the machine. This design are typically designed

### OBJECTS AND ADVANTAGES

Accordingly, several objects and advantages are:
(a) to provide a business practice of manufacturing Polyurethane footwear and other Polyurethane products that is simpler and less costly than existing methods;
(b) to provide for the licensing of manufacturers who use the PolyWear Manufacturing System;
(c) to provide a manufacturing process for Polyurethane footwear consisting of two or more parts made from different formulas that is simpler and less expensive than existing processes;
(d) to provide a manufacturing process for most Polyurethane products consisting of two or more parts made from different formulas that is simpler and less expensive than existing processes;
(e) provide packaged resources to licensed Polyurethane footwear manufactures including injection molding, molding table;
(f) provide packaged resources to licensed Polyurethane footwear manufactures including injection molding footwear molds;
(g) provide packaged resources to licensed Polyurethane footwear manufactures including manufacturing plans;
(h) provide packaged resources to licensed Polyurethane footwear manufactures including injection molding manufacturing supplies and consumables;
(i) provide packaged resources to licensed Polyurethane footwear manufactures including Polyurethane;
(j) provide packaged resources to licensed Polyurethane footwear manufactures including product design;
(k) provide packaged resources to licensed Polyurethane footwear manufactures including marketing programs;
(l) provide packaged resources to licensed Polyurethane footwear manufactures including a technician skilled in the operation of equipment and full use of system;
(m) to provide to licensed Polyurethane footwear manufactures the software and business systems to efficiently operate the PolyWear Manufacturing System;
(n) to provide a complex mold for molding Polyurethane products including footwear that allows for the simultaneous injection of Polyurethane into two or more sections of the mold thus significantly reducing production time;
(o) to provide a complex mold where the outsole and the insole/upper/shaft of footwear can be injected simultaneously thus significantly reducing production time;
(p) to provide a complex mold with dual rotating or shuffling sole plates;
(q) to provide a complex mold with auto rotating dual sole plate;
(r) to provide a complex mold with manual shuffling sole plates;
(s) to provide a complex mold with unique closure and locking systems;
(t) to provide a complex mold with unique closure guides;
(u) to provide a complex mold designed for mounting on the masts of the linear molding table;
(v) to provide a complex mold with assisted opening system;
(w) to provide a complex mold with a unique hinge system for shuffling sole plates;
(x) to provide a complex mold with handles for manipulating shuffling sole plates;
(y) to provide a complex mold with manual or assisted moving last moving independent of the mold and enabling easy footwear removal;
(z) to provide a complex mold with multiple injection ports and/or port closures;
(aa) to provide a multi-station linear molding table designed to simultaneously inject two or more sections of the same complex mold with a Polyurethane formula;
(bb) to provide a multi-station linear molding table designed to inject any one mold section or combination of mold sections of the same complex mold at the same time;
(cc) to provide a multi-station linear molding table designed to inject the outsole and the insole/upper/shaft of a complex footwear mold simultaneously thus significantly reducing production time;
(dd) to provide a multi-station linear molding table capable of fully servicing from one pair of complex molds to eighteen pairs of complex molds or more as described herein;
(ee) the multi-station linear molding table is designed to take full advantage of the advanced mold by rapidly producing as many pairs of boots as desired over a given period of time. This speedy cycling is possible only with the combination of mold and molding table describe herein.
(ff) the multi-station linear molding table is designed to continue operations while molds are being changed and/or some type of service is being performed on the equipment. A single pair of molds or select group of multiple molds can be virtually turned off so the molding table continues producing boots using the non effected molds. This unique ability allows for the maximum production levels to be reach.
(gg) the multi-station linear molding table includes a computer controller which coordinates operations with the injection molding machines to simply and efficiently manage the entire production process.
(hh) the multi-station linear molding table software and operating system is designed to monitor and/or control all functions of the equipment and production process. The information gathered is then automatically transmitted to select oversight computers both locally and at the Licensors facility.
(ii) the multi-station linear molding table which provides rotating mold system allowing for optimal injection angle and moves to an optimal angle for footwear/boot removal;
(jj) the multi-station molding table is equipped with multiple masts designed to hold two molds, one either side, a left and right foot one;
(kk) the multi-station linear molding table with multiple masts designed to hold a single mold;
(ll) the multi-station linear molding table with masts designed to rotate molds automatically or semi-manually;
(mm) the multi-station linear molding table with either a slide based arm or slide based tracking system to move the injection head(s) into selected positions in response to controllers direction;
(nn) the multi-station linear molding table with an injection head guide system;
(oo) the multi-station linear molding table with twin injector head system;
(pp) the multi-station linear molding table with floor covering system to protect hoses and controls;
(qq) the multi-station linear molding table with a lighted information and signaling system;
(rr) the multi-station linear molding table with an exhaust duct for removing mold release over spray and for mold cooling;
(ss) the multi-station linear molding table with heated supply lines for injected materials;
(tt) the multi-station linear molding table with both mold release and compressed air dispensing systems mounted at each set of molds;
(uu) the multi-station linear molding table with a mounting system for rotating sole plate and power assisted and/or automatic rotator;
(vv) the multi-station linear molding table with a hydraulic or electric lift/locking system for shuffle sole plates and/or rotating sole plate;
(ww) the multi-station linear molding table with a wheeled cart designed to hold molds and position them for mounting and dismounting on the masts on the molding table;

Further objects and advantages will become apparent from a consideration of the ensuing description and drawings.

### SUMMARY

This invention embodies both a new business method and practice for the manufacturing of injection molded polyurethane footwear as well as the design of certain equipment used in this manufacturing process. The equipment involves a new mold design which enables a dual injection head to inject two different materials into two separate cavities of a single mold at the same time. Other equipment includes a multi station linear molding table designed to accommodate the aforementioned new mold. The unique design of the aforementioned molding table allows for it to be serviced and molds to be changed without halting production or shutting the equipment off. Using the invention the process of manufacturing this injection molded polyurethane footwear can be substantially shortened thus reducing the manufacturing costs and retail pricing.

The business method and practice will allow for existing footwear manufacturers to add this product line to theirs by simply licensing the use of the invention.

### DRAWINGS—FIGURES

FIG. 1 diagrams the equipment and services offered with the leasing agreement to those using the invention. The Lessor would supply the Lessee with: the necessary injection molding machines and equipment to produce the product; the installation of all machines and equipment; an internet based management system; full sales and marketing support; 24 hour 7 days a week technical support; full technical and mechanical support; continuing footwear product design; provide initial molds; a full set of new molds would be supplied each year; provide redundant security systems; electronic management; on-site and campus training of personnel; on-site Technical Manager; and, all raw materials needed for manufacturing.

The Licensee would then pay a royalty fee on each pair of footwear sold and also a fee or commission on the raw materials purchased from the Lessor.

FIG. 2A shows a front view of the dual rotating sole-plate system. This shows part 1, the dual rotating sole-plate with the identical impression in opposite sides and part 2, the bed section of the system with a contour matching the insole of the product to be molded. Part 5 is the cavity for the outsole and part 8 the injection ports. Part 6 is the last and part 7 is the last extension. Part 4 indicates the perimeter of the molded footwear.

FIG. 2B shows a side view of the dual rotating sole-plate system. Part 1 is the dual rotating sole-plate and part 2 is the bed section of the system. Part 5 is the cavity for the outsole and part 8 the injection ports. Part 6 is the last and part 7 is the last extension. Part 4 indicates the perimeter of the molded footwear.

FIG. 3A shows a front view of the dual shuffling sole-plate system. Part 3 are identical shuffle sole-plates. Part 23 is the hinge system which attaches the shuffling sole-plate to the primary mold for the insole/upper/shaft of the footwear product. Part 5 is the cavity for the outsole and part 8 the injection ports. Part 6 is the last and part 7 is the last extension. Part 4 indicates the perimeter of the molded footwear.

FIG. 3B shows a side view of the dual shuffling sole-plate system. Part 3 are identical shuffle sole-plates. Part 5 is the cavity for the outsole and part 8 the injection ports. Part 6 is the last and part 7 is the last extension. Part 4 indicates the perimeter of the molded footwear.

FIGS. 4A to 4C shows the front view, side view and back view of the dual rotating sole-plate injection molding system in a closed position. Part 1 is the dual rotating sole-plate and part 2 is the bed section of the dual rotating sole-plate system. Part 7 is the last extension and part 8 is the injection port. Part 9 is the primary mold for the insole/upper/shaft of the footwear and part 10 is the locking system to hold the mold securely together. Part 11 is the rotating sole-plate mold compression locking system and part 12 are the spring loaded hinges for opening and closing the primary mold. Part 13 are the handles to manually manipulate the dual rotating sole-plate and part 14 is the guide for the lift system. Part 17 is the lifting system and part 18 is the primary mold opening system roller bearings. Part 19 is the system to move the last 90 degrees for removal of the footwear and part 20 is the static reinforcement to the single mast mount. Part 21 is a drive system for a locking mechanism.

FIGS. 5A to 5F show a back view of the dual rotating sole-plate injection molding system in a sequence of opening, rotating and closing.

FIG. 5A shows the dual rotating sole-plate injection molding system and the lifting system begins to lower the mold using the guide system part 14.

FIG. 5B shows the dual rotating sole-plate injection molding system lifting system lowering the mold parts so that they automatically fully open.

FIG. 5C to 5E shows the dual rotating sole-plate injection molding system with the dual sole-plate being turned 180 degrees either manually or automatically.

FIG. 5F shows the dual rotating sole-plate injection molding system closed with the dual sole-plate rotated 180 degrees. This reversing of the sole-plate positions allows a molded outsole to be placed in position for the insole/upper/shaft to then be molded directly to it.

FIGS. 6A to 6B show the front and side view of the dual shuffle sole-plate system and locking system. Part 17 is a lift locking system that holds the shuffle sole-plates securely in the closed position. Part 25 is an alternative complex locking system attached to both sides of the primary mold which operated with a drive system securely holds the shuffle sole-plates in the closed position.

FIGS. 7A to 7C show the complete mold system rotating 90 degrees on the dual mount mast. This allows for easier removal of the finished molded product.

FIG. 8 shows the complete mold with the dual shuffle sole-plate in the horizontal position and fully open for the removal of the footwear product.

FIGS. 9A to 9B show the side view and top view of a single mold mounted to the mast of the molding table. This mount enables the mold to rotate 90 degrees from the vertical injection position to the horizontal footwear removal position.

FIG. 10 shows a pair of molds mounted to the mast of the molding table. This mount enables the mold to rotate 90 degrees from the vertical injection position to the horizontal footwear removal position.

FIGS. 11A to 11E show the back view of the complete mold using the dual shuffle sole-plate molding system in a sequence exchanging one sole-plate with the other. This reversing of the sole-plate positions allows a molded outsole to be placed in position for the insole/upper/shaft to then be molded directly to it.

FIG. 12 shows a side view of a complete mold using the dual shuffle sole-plate molding system in an open position using the option where only the last mechanism moves 90 degrees for the removal of the product.

FIG. 13 shows a side view of a complete mold using the dual rotating sole-plate molding system in an open position using the option where only the last mechanism moves 90 degrees for the removal of the product.

FIGS. 14A to 14C shows the side, front and top views of the complete mold mounted to individual masts on the molding table. This method of mounting molds provides an unobstructed path for the dual injection head to inject both the top and bottom ports of the mold.

FIG. 15 shows a top view of the linear injection molding table equipped with the injection head linear slide and supply hose arm. Part A is the typical high pressure polyurethane injection molding machine. Part 0 is the base molding table and part 2 is the supply hose arm. Part 1 is the control unit and interface and Part 1A is the lighted information and signaling system. Part 3 is the cleanout position for the twin injection head and part 4 is the set or pair of molds mounted on individual masts. Part 5 is the injection head guide system and part 6 is the dual piping system for mold release and compressed air. Part 7 is the dual high intensity fluorescent light fixtures mounted overhead.

FIGS. 16A to 16B show the back and front view of the linear injection molding table equipped with the dual mast stationary mold system. Part 2 is the supply hose arm and part 13 is the twin injection head. Part 8 is the mold release dispensing system and part 9 is the compressed air dispensing system. Part 10 is the mold mounted color signaling system. Part 11 is the exhaust duct for removing mold release and part 12 is the individual mold duct and grate. Part 14 is the mast for single mold mounting.

FIGS. 17A to 17B show the back and front view of the linear injection molding table equipped with the single mast rotating mold system. Part 2 is the supply hose arm and part 13 is the twin injection head. Part 8 is the mold release dispensing system and part 9 is the compressed air dispensing system. Part 10 is the mold mounted color signaling system. Part 11 is the exhaust duct for removing mold release and part 12 is the individual mold duct and grate. Part 15 is the mast for dual rotating mold mounting.

FIG. 18 shows a top view of the linear injection molding table equipped with the injection head linear slide and supply hose tracking system. Part 17 is the flexible tracking system holding the injection supply hoses and part 18 is the twin injection head and tracking system interface.

FIGS. 19A to 19B show the back and front view of the linear injection molding table equipped with the dual mast stationary mold system. Part 17 is the flexible tracking system holding the supply hoses and part 5 is the injection head guide system. Part 13 is the twin injection head and part 16 are the supply hoses and controls protected by a special floor covering. Part 8 is the mold release dispensing system and part 9 is the compressed air dispensing system. Part 10 is the mold mounted color signaling system. Part 11 is the exhaust duct for removing mold release and part 12 is the individual mold duct and grate. Part 14 is the mast for single mold mounting.

FIGS. 20A to 20B show the back and front view of the linear injection molding table equipped with the single mast rotating mold system. Part 17 is the flexible tracking system holding the supply hoses and part 5 is the injection head guide system. Part 13 is the twin injection head and part 16 are the supply hoses and controls protected by a special floor covering. Part 8 is the mold release dispensing system and part 9 is the compressed air dispensing system. Part 10 is the mold mounted color signaling system. Part 11 is the exhaust duct for removing mold release and part 12 is the individual mold duct and grate. Part 15 is the mast for dual rotating mold mounting.

### DRAWINGS—REFERENCE NUMERALS

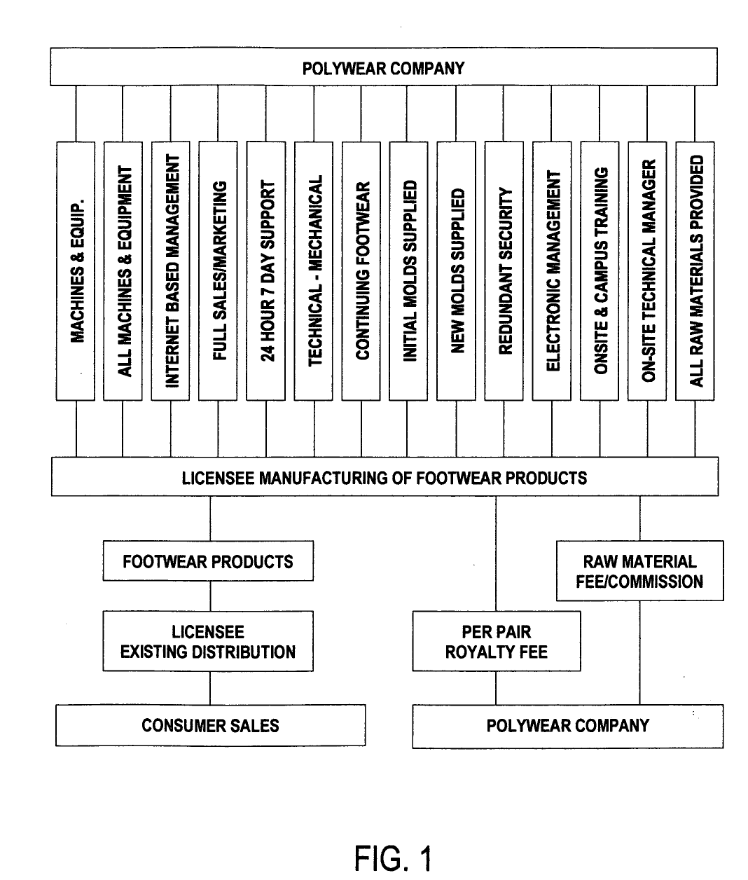

FIG. 1 no specific reference Numerals

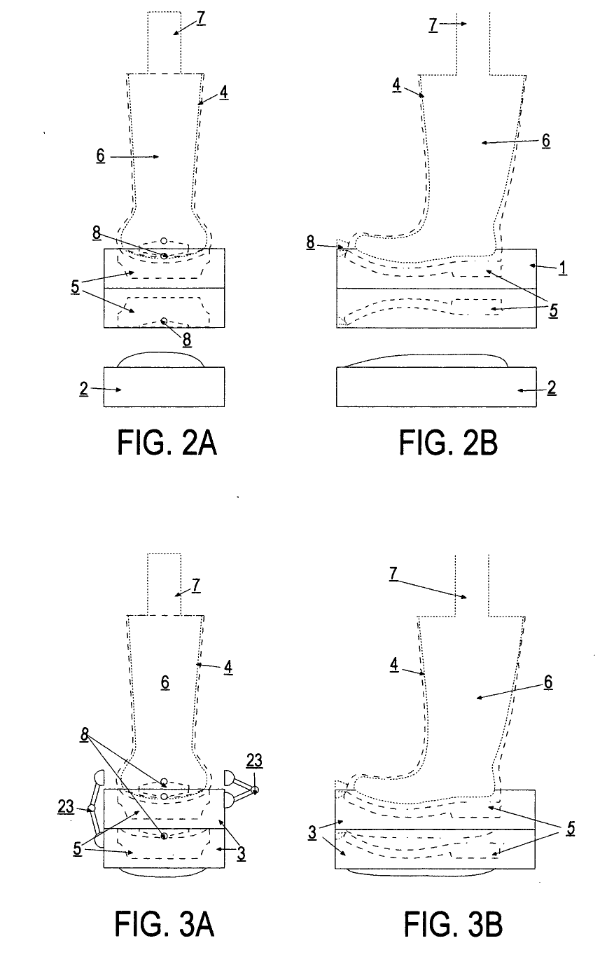

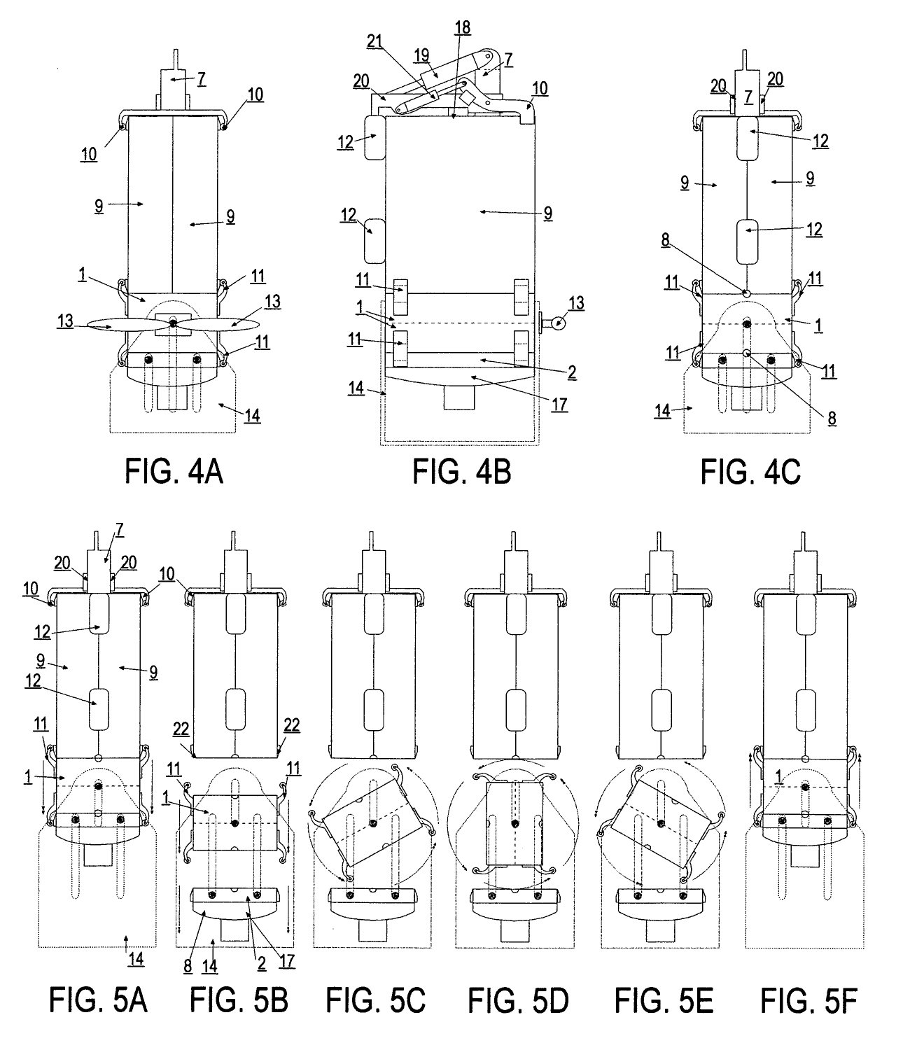

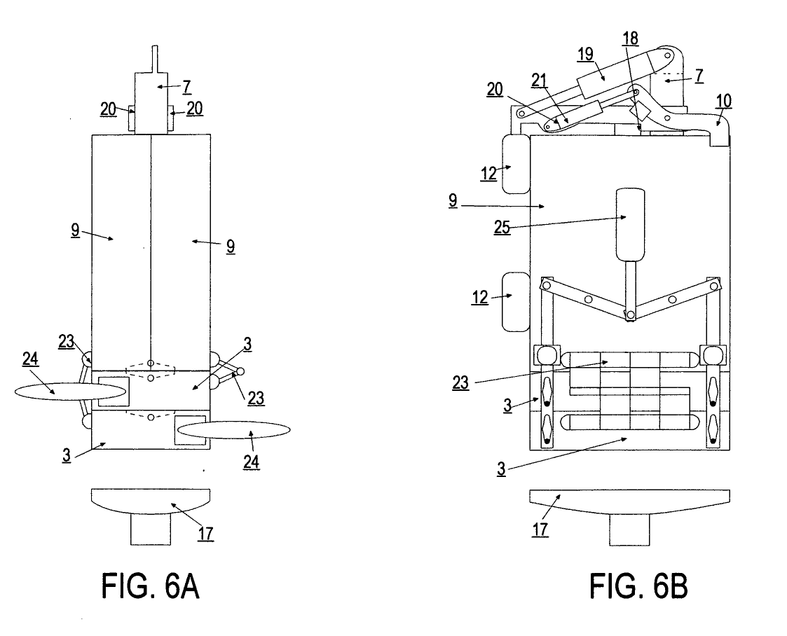

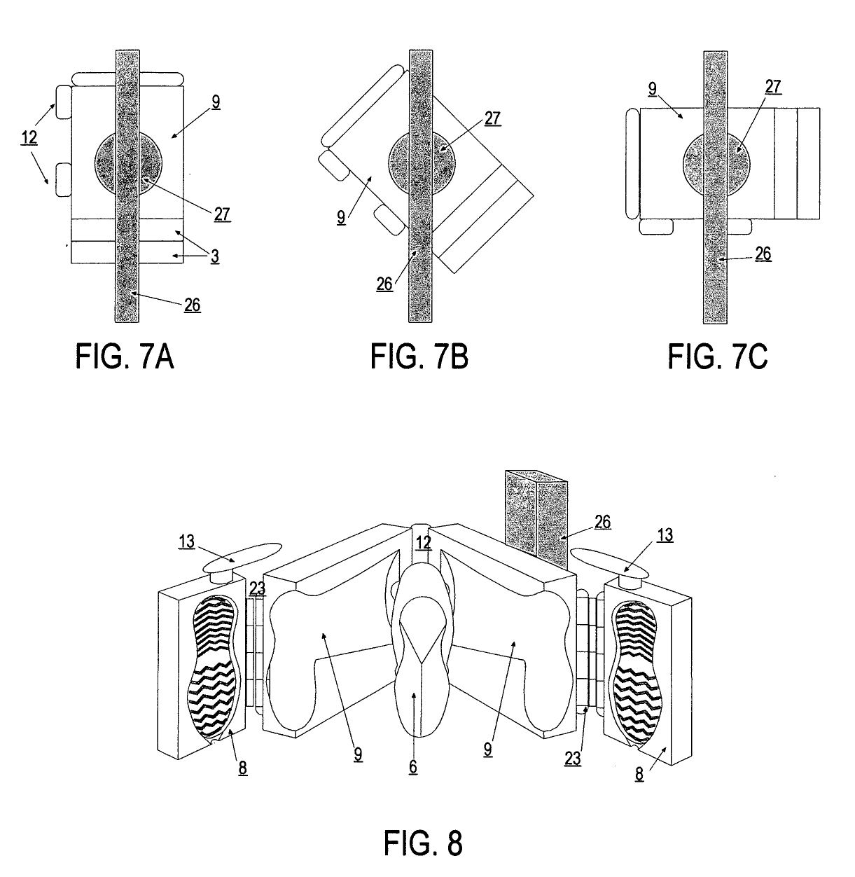

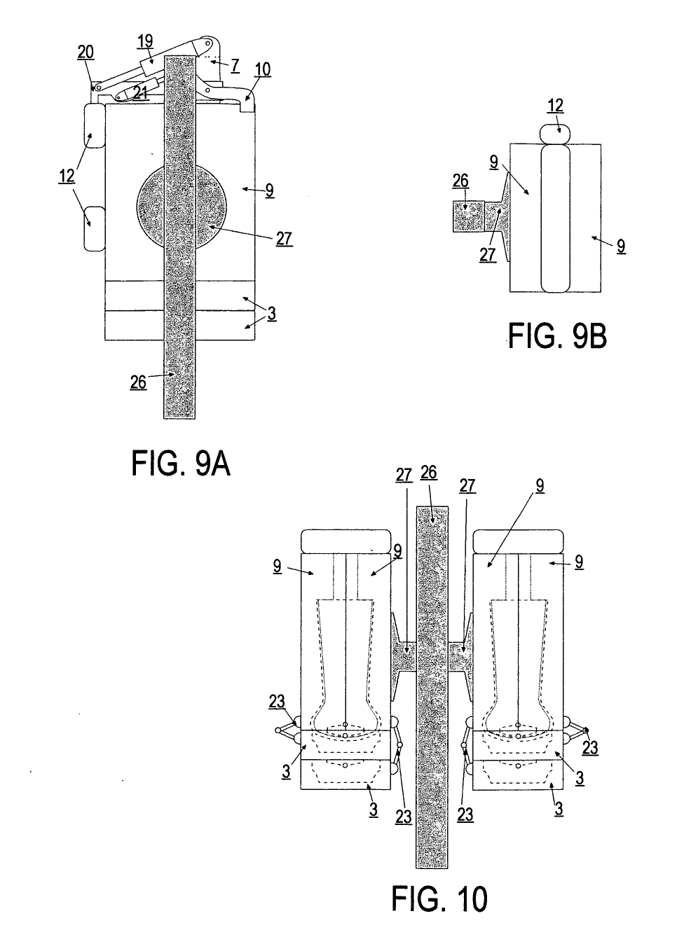

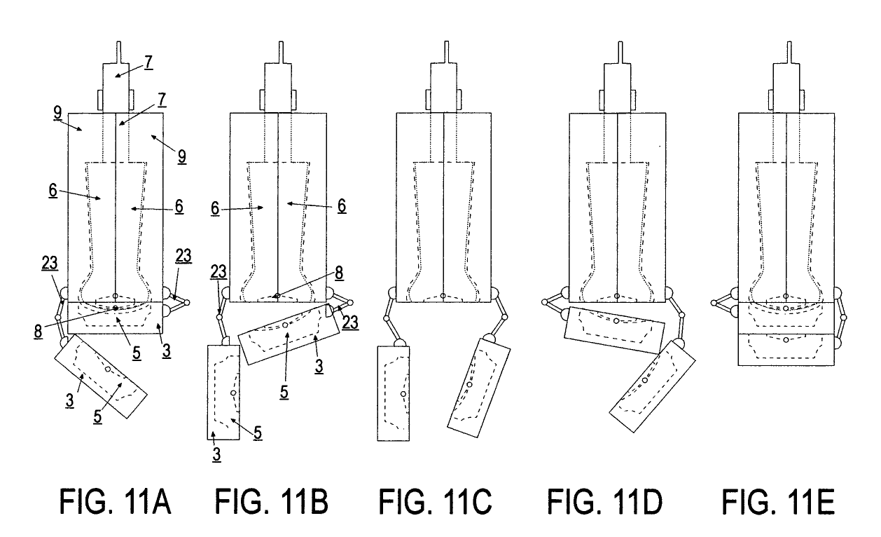

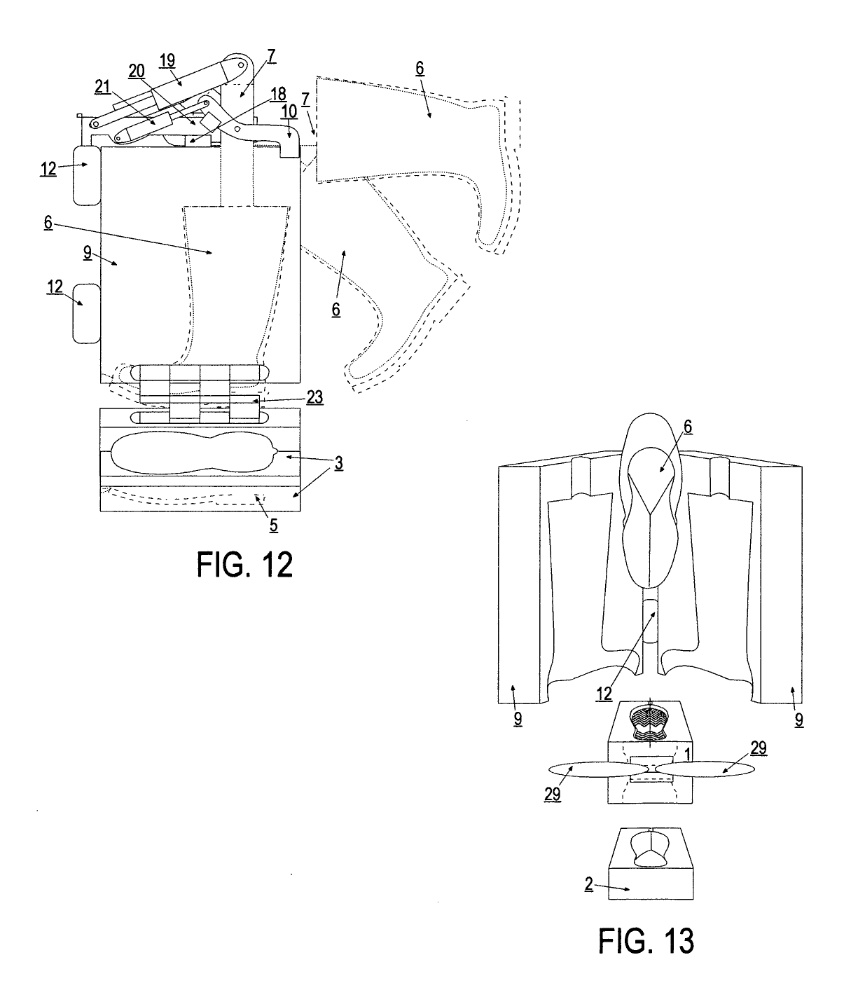

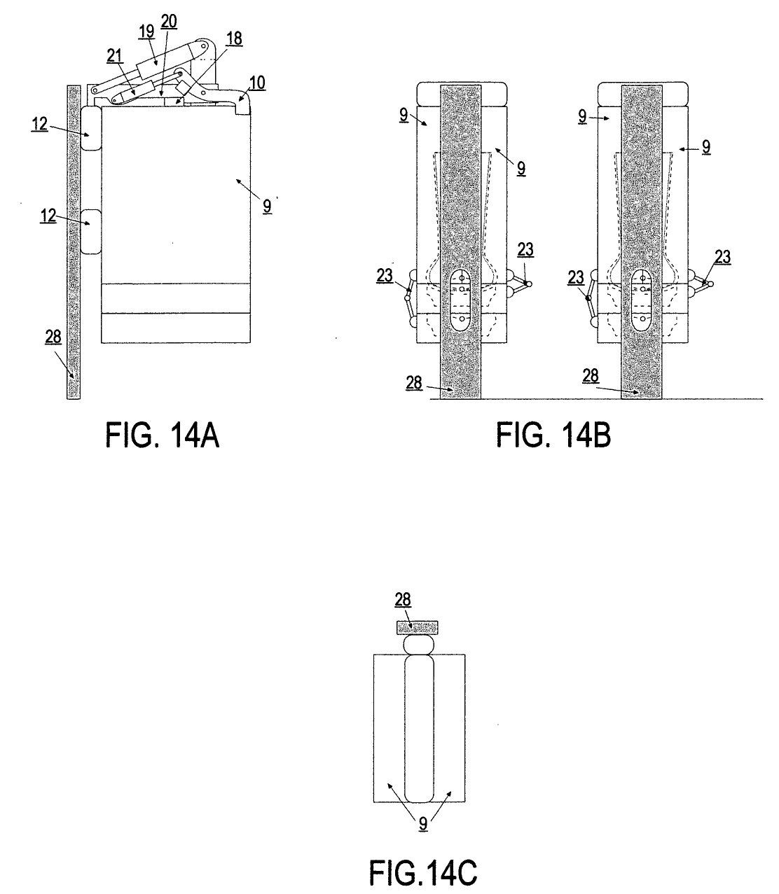

FIGS. 2 to 14
Part 1 is a dual rotating sole-plate
Part 2 is the bed section of the dual rotating sole-plate system
Part 3 is the shuffle sole-plate of the dual shuffle sole-plate system
Part 4 is the molded boot/shoe
Part 5 is the outsole cavity in the sole-plate
Part 6 is the last
Part 7 is the last extension used for connections
Part 8 is the injection port
Part 9 is the boot/shoe insole/upper/shaft mold or primary mold
Part 10 is the piston driven top locking system to hold mold together
Part 11 is the rotating sole-plate mold compression locking system
Part 12 is the spring loaded hinge system for opening and closing mold
Part 13 is the dual handle/grip for turning rotating sole-plate mold
Part 14 is the guide for the lift system
Part 17 is the lift system
Part 18 is the mold opening system roller bearings
Part 19 is the piston driven system to move the last 90 degrees for boot/shoe removal
Part 20 is the static metal reinforcement attached to the shingle mast mount
Part 21 is the piston drive for part 10 mold locking system and automated mold opener
Part 22 is the contact pad for part 11 compressing locking system
Part 23 is the hinge system for dual shuffle sole-plate molds
Part 24 is the single handle/grip for maneuvering dual shuffle sole-plate mold
Part 25 is the complex piston driven locking and opening system for sole-plate molds
Part 26 is the dual mount mast for either mold mount
Part 27 is the rotation system for the dual mount rotation molding system
Part 28 is the single mount mast for either mold mount

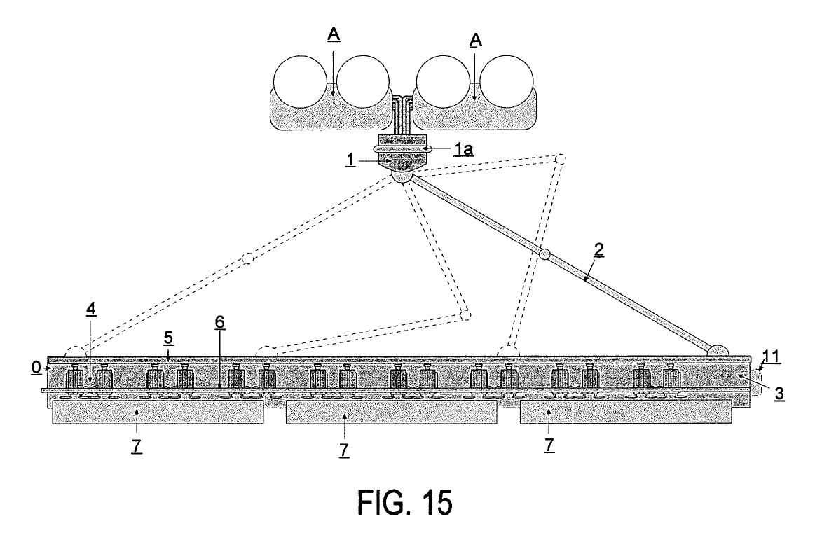

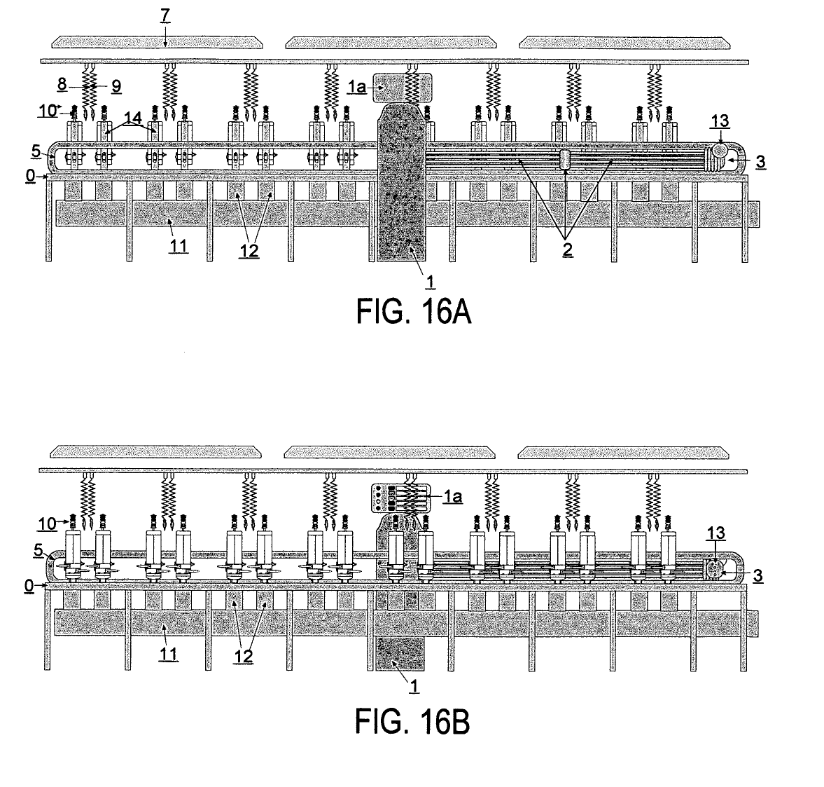

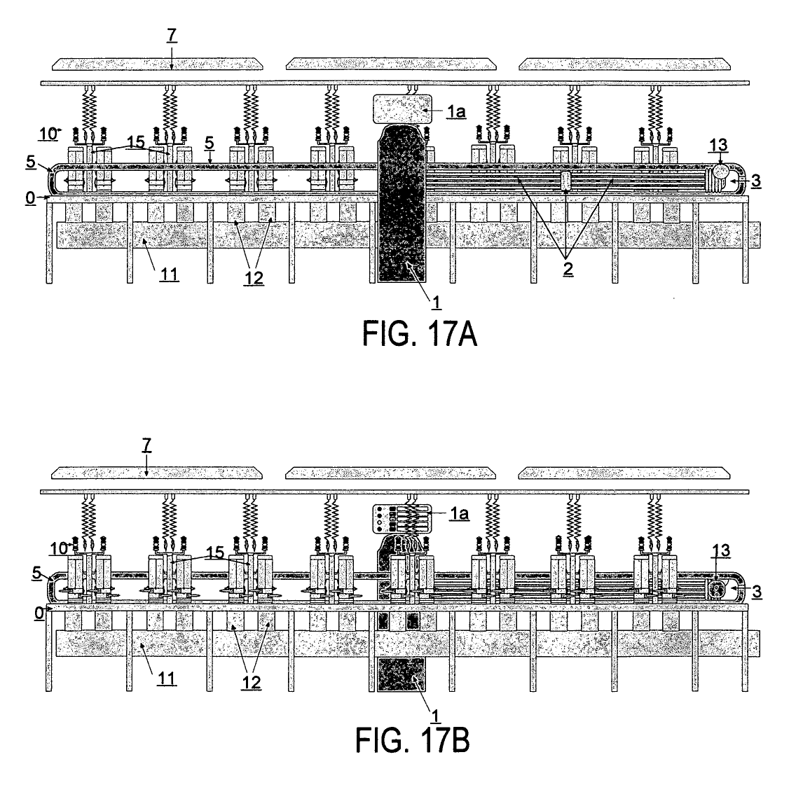

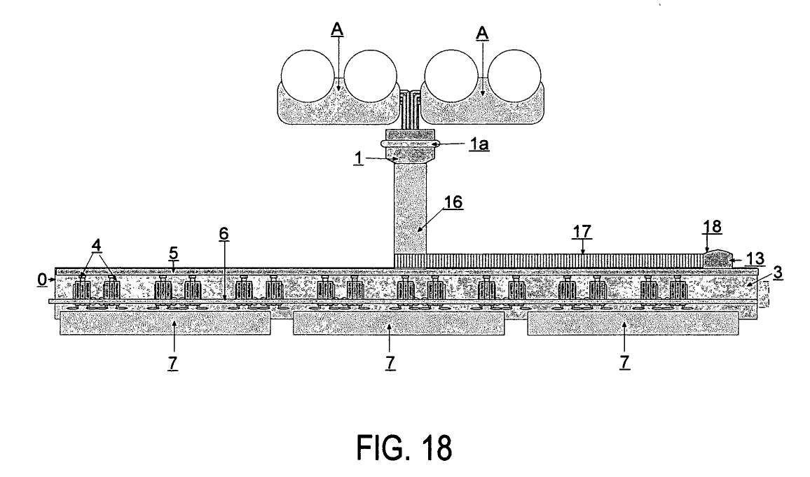

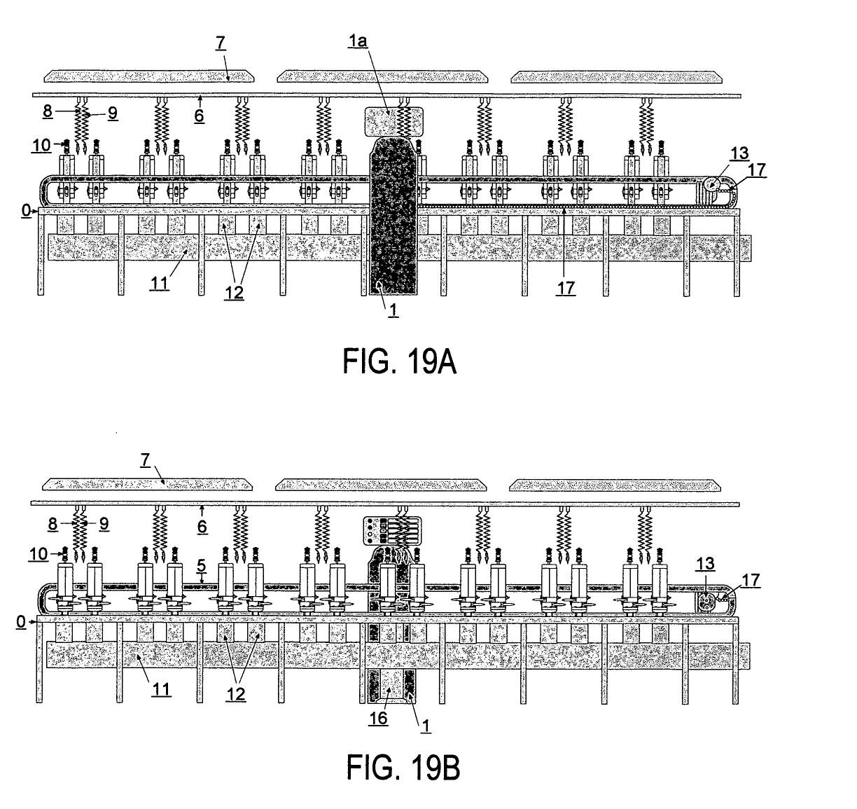

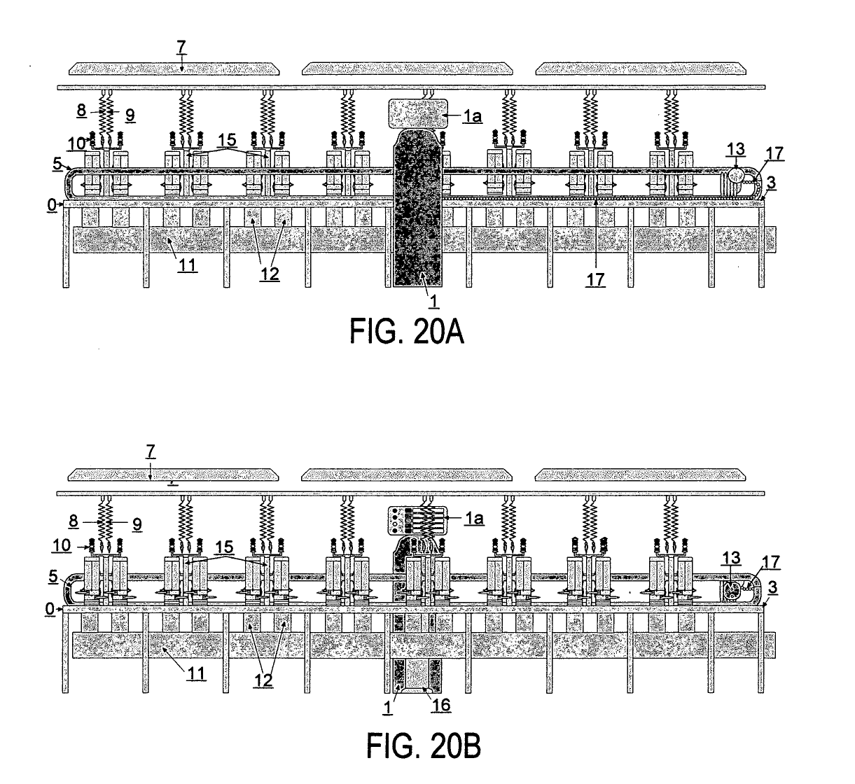

FIGS. 15 to 20
Part A is a typical high pressure polyurethane injection molding machine
Part 0 is the base molding table
Part 1 is the control unit and interface
Part 1a is the lighted information and signaling system
Part 2 is the supply hose arm
Part 3 is the clean-out position for the twin injection head
Part 4 is a set/pair of molds mounted on individual masts
Part 5 is the injection head guide system
Part 6 is the dual piping system with mold release spray and compressed air
Part 7 is the hanging dual high intensity fluorescent lighting system
Part 8 is the coiled hose mold release dispensing system
Part 9 is the coiled hose compressed air dispensing system
Part 10 is the mold mounted color signal light system
Part 11 is the exhaust duct for removing mold release over spray and mold cooling
Part 12 is the individual mold duct and grate
Part 13 is the twin/dual injection head
Part 14 is the mast for single mold mounting
Part 15 is the dual mount mast for mounting both molds of a pair
Part 16 is the injection hoses and controls protected by floor covering system
Part 17 is the flexible tracking system holding injection hosed and controls
Part 18 is the twin/dual injection head and tracking system interface

### DETAILED DESCRIPTION—FIG. 1

One objective is to provide the licensee with a turnkey process for adding a new product or products to an existing product line with relatively low startup cost. The inventor or PolyWear would provide the equipment and service as outlined in FIG. 1.

(1.) The patent pending polywear manufacturing system is a custom high or low pressure injection molding machine system and molding table system designed to use special molds in the production of injection molded polyurethane footwear and/or footwear components.

(2.) The patent pending polywear manufacturing system may use any Injection molding machine with capabilities within the set specifications and standards for the system.

(3.) A fee is paid by the Licensee, a company, typically a domestic footwear manufacturer already producing protective footwear or interested in producing protective footwear. This fee is an annual charge for the rights to use the Patent pending polywear manufacturing system. This fee may be charged each year and may increase or decrease each year per the terms of the licensing agreement. In return for the Licensing fee the Licensee with receive:
(a) Use of a single polywear manufacturing system. This equipment will be shipped to the Licensee's location, installed and then overseen and administered onsite by a PolyWear Technical Manager, all at the expense of polywear;
(b) With the installation of the patent pending polywear manufacturing system the Licensee will receive a free set of footwear molds consisting of 8 to 12 pairs. Should the Licensee's rate of production be high and require additional molds, a second set or partial set will also be provided free;
(c) The Licensee will be required to purchase all raw materials in the form of special polyurethane formulations and other formulations from polywear and other items at a rate competitive for each licensee's distinctive market.
(d) Polywear designers will continue to develop new competitive footwear designs and molds throughout the year and provide each Licensee with a complete set of new molds each year, 8 to 12 pairs per set. Should the licensee's production demands dictate the need for additional partial or complete mold sets they will be provided at no cost by polywear. The footwear and mold designs may be drawn from trends and needs within the Licensee's domestic market or may be of a more general type directed at a larger regional or worldwide market group.
(e) The Licensee would receive at no additional charge additional PolyWear Manufacturing System equipment when production demands exceeds the capabilities of the first polywear manufacturing system. This is a basic “system guarantee”, once a company becomes a Licensee they are guaranteed enough equipment and molds to meet their production demands. This guarantee is limited to the reasonable capabilities of polywear and is also dependent on venders capabilities and schedules.
(f) The Licensee may also receive at no cost customized assistance and materials from the polywear's marketing and advertising Team for the purpose of selling Patent Pending polywear Manufacturing System products to their; distributors, retailers and directly to their customers. These efforts may be unique for the individual Licensee and/or part of a greater marketing/promotional campaign.
(g) Polywear would provide 100% of the maintenance needs on all equipment used in the patent pending polywear manufacturing system on a 24 hour a day, 7 days a week basis. This may help insure a licensee can obtain the maximum production levels desired providing they have taken care to make sure other necessary issues are met. The onsite polywear technician would help in this area as part of their normal job responsibilities.
(h) Licensee will have full technical support available via the Internet and polywear's web site available 24 hours a day, 7 days a week including holidays.
(i) Polywear will provide the licensee's select employees with specialized training either onsite or at the Campus located at the polywear company headquarters.

(4.) The patent pending polywear manufacturing system's linear footwear injection molding table system (LMT-1) is equipped with a custom computer hardware, software and communications system. This system provides for the real-time communication of information from the licensee's site to the administrative computer system located at the polywear company headquarters. This system provides 24/7 monitoring of the systems production data, equipment status and insures raw materials are received on time. The system also alerts the corporate office of any maintenance needs that are detected as well as managing regularly scheduled maintenance issues.

(5) The patent pending polywear manufacturing system includes custom computer programs and hardware designed to either fully automate or partially automate certain functions of the production/manufacturing operations as well as support materials and supplies management and other logistics.

(6) In addition to any lessening fee, the licensee's will pay polywear a royalty fee for each pair of footwear manufactured by the polywear manufacturing system or any part of the system. The amount of royalty may differ for; different licensee's, licensee's in different locations or markets, different amounts or fees for different types of footwear, and other reasons.

(7) An electronic monitoring system with security failsafes will be integrated into the patent pending polywear manufacturing system. This process may utilize the internet, satellite technology or other means for guaranteed communication links. This system will alert polywear of all system operations including the amount of raw materials used, number of pairs made, hours machine runs, etc. This system is designed to reduce certain types of fraud or equipment use contrary to the licensing agreement as well as send alerts that certain types of repairs or adjustments on the System and equipment need to be made or will need to be made in the near future.

(8) Polywear will develop agreements with one or more raw material providers including polyurethane manufactures. These agreements may allow these manufactures to pay polywear a commission or other compensation of some type in return for sales to polywear Licensees. Polywear may undertake agreements such as this with more than one raw material supplier including polyurethane. Multiple suppliers would then provide the most competitive pricing of raw materials including polyurethane to polywear licensees.

### DETAILED DESCRIPTION—FIGS. 2 TO 14

Part 1 is the dual rotating sole-plate. There are two parts to this system, (a) the rotating section and, (b) the bed section. The rotating section is comprised of two identical molds and molds the outsoles of the boots/shoes. This dual rotating sole-plate is rotated at the time a completed boot/shoe is removed from the mold system. This places a freshly injected outsole in position next to the insole/shaftupper. The cycle then continues and the insole/shaft/upper is injected onto the previously shot outsole and a new outsole is simultaneously shot which will be used during the next cycle. The bed section is simply a reproduction of the insole shape and is aligned with the sole-plate when the outsole is shot.

Part 2 is the bed section of the dual rotating sole-plate system. The bed section is used with the dual sole-plate to produce an outsole with the proper contours used when the insole/shaft/upper is injected/shot thus producing the desired insole.

Part 3 is the sole-plate of the dual shuffle sole-plate system. The sole-plates of the dual shuffle plate are connected via a specialized hinge system, Item 23. These special hinges allow for either of the two sole-plates to be positioned against the insole/shaft/upper mold and visa versa.

The production set injection process has three cycles: the first or startup cycle is to move one by one down the line of molds on the molding table and shoot/inject the lower outsole mold. The second or standard cycle is to repeatedly move down the line of molds injecting the insole/shaftupper onto the previously shot outsole and a new outsole for use on the next boot/shoe. The third or shutdown cycle is for the Injection head to move one by one down the molds injecting the insole/shaftupper onto the previously injected/shot outsole thus completing the boot/shoe.

Part 4 is the molded boot/shoe. This just an example of the outline of a molded boot using this mold.

Part 5 is the outsole cavity in sole-plate. This is the cavity area which is closed by either the bed section when using the rotating system or the second sole-plate when using the Shuffling System. When closed and injected the sole-plate produces a finished outsole ready for the insole/shaft/upper to be molded onto it.

Part 6 is the last. This is the typical footwear mold Last with an internal air system to assist with the removal of finished boot/shoe. The last is either stationary on the rotating mold or moves 90 degrees for boot/shoe removal on the single mast static system.

Part 7 is the last extension used for connections. This extension extends outside the mold and is used to connect and align the last with the other parts of the mold and interface with other mechanical devices comprising the system.

Part 8 is the injection port. This is a typical injection port designed to interface with whatever injection molding machine is used with the system. The port path widens and becomes thinner as it dispenses the materials along the joint between the insole/shaft/upper and the outsole.

Part 9 is the boot/shoe insole/shaft/upper mold, primary mold. These are the two halves of the insole/shaft/upper Mold which incase the Last and connect to the sole-plate.

Part 10 is the piston driven top locking system to hold the mold together. This complex system consist of a pivoting shaped metal device with two planes which is moved by a piston or other system. The device engages it's locking system when lowered over the top of the insole/shaft/upper mold. Using this compression locking system the outside legs are fitted with roller bearings that are lowered over the mold and compress the contact pads, part 22, thus holding the top of the mold tightly together for molding.

The second plane deals with when the device is raised. First the roller bearings will clear the top of the mold and no longer participate in holding it together. As the device is moved further a specially designed wedge on the device slowly moves down between to roller bearings attached to different sides of the mold. As the wedge is lowered it separates the mold halves from around the last. The spring/tension assisted hinges then fully open the mold.

Part 11 is the rotating sole-plate mold compression locking system. The compression locking system uses four tension devices with roller bearings on all four corners of the sole-plate. This is true on both the upper and lower sections of the dual sole-plate thus totaling 8 devices. These work in conjunction with the contact pad, Item 22 and not only holds all sections of the mold tightly together well within specifications.

Part 12 is the spring loaded hinge system for opening and closing mold. These are complex hinges with adjustable tension levels for holding the hinge in the open position. When attached they insure the two halves of the insole/shaft/upper mold will slowly fully open once all the locking systems are disengaged. One option is to have an internal or external catch to hold the mold halves closed until the locking systems are engaged. This catch would disengage automatically when the locking systems engaged.

Part 13 is the dual handle/grip for turning rotating sole-plate mold. These are aluminum or wooden handles mounted to make is easier to rotate and align the dual sole-plate.

Part 14 is the guide for the lift system. This frame and guide can be made of a variety of materials and is designed to align and move the sole-plate and bed section from molding positions to demolding positions.

Part 17 is the lift system. This lifting system may be hydraulic driven or operated by some other means but involves a lowering/lifting path sufficient to rotate the dual sole-plate. Alignment is critical and easy to adjust.

Part 18 is the mold opening system roller bearings. A set of roller bearings are located at the top of the mold, one bearing attached to each half of the mold. A leaver device, Item 10, is automated and lowers a wedge system between the roller bearings causing the mold to open. The spring/tension assisted hinges then fully open the mold.

Part 19 is the piston driven system to move the last 90 degrees for boot/shoe removal. This is a simple movement device wither piston or other type which will attach to the top connection of the last. This device is automated and uses adjustable tension hinge system. This system automatically raises the last to 90 degrees once all the locks are disengaged. At the 90 degrees location it is much easier to remove the boot/show from the last.

Part 20 is the static metal reinforcement attached to single mast mount. This is a optional extension of the single mast mount which provides both connection opportunities for items and a static brace to hold the mold secure when using the hydraulic lift system,

Part 21 is the piston drive for part 10 mold locking system and automated mold opener. This is the simple piston or other drive system used to lift and lower the locking/opening device, FIG. 10.

Part 22 is the contact pad for part 11 compression locking system. This is a simple pad affixed to the mold in certain places corresponding to the use of the compression locking system which uses four tension devices with roller bearings on all four corners of the sole-plate. This is true on both the upper and lower sections of the dual sole-plate thus totaling 8 devices. Furthermore a dual system can engage by lowering from the top of the mold holding the mold securely together for the molding process.

Part 23 is the hinge system for dual shuffle sole-plate molds. These specially designed hinges have a certain amount of “play” in them which when the sole-plates are loose enables the sole-plates to be positioned one on top of the other either way. For instance the left sole-plate may be positioned on top and the right sole-plate positioned on the bottom or visa versa. The right sole-plate positioned on the top and the left sole-plate positioned on the bottom. In either case once positioned the mold set can be secured/locked into place for the injection process. These hinges are removable and designed to be used on other molds as well.

Part 24 is the single handle/grip for maneuvering dual shuffle sole-plate mold. This single handle/grip is designed to provide easy movement of each individual sole-plate in a shuffle system. Working with other components this maneuvering and positioning system allows for the fast manipulation of the sole-plates and easy alignment for locking and injection.

Part 25 is the complex piston driven locking and opening system for sole-plate molds. This is one of the many Locking and/or opening systems for the sole-plates. This system uses a series of levers to pull sole-plates together tightly for injection and to push the sole-plates apart for mold opening, removal of boot/shoe and switching of sole-plates placing the previously injected/shot sole-plate in position for the next standard injection cycle. Moved up and down by the mechanical levers the four contact plate are designed to move away from the sole-plate when they are lowered and the sole-plates are unlocked. The contact plates may also have a function of pushing the sole-plates away from the upper mold and away from each other thus making it much simpler to open the molding system, remove the boot/shoe, prepare it for the next injection cycle and position the previously injected/shot sole-plate

Part 26 in the dual mount mast for either mole mount. This mast allow for two different mounting system options. First, a mold set (left & right) are mounted to the sides of the mast using the rotation system for dual mount rotation molding systems. Facing the machine and system the Molds are typically mounted right on right and left on left. The second mounting option is to mount a mold set to a single mast without the rotating system. This may be accomplished using optional mold hinge mounting hardware. This method would typically mounted right on right and left on left directly to the mast.

Part 27 is the rotation system for dual mount rotation molding system. This is a balanced and aligned rotating device. It provides for the soft and controlled rotation of a single mold. This device may include a tension system which would automatically move the mold 90 degrees to horizontal position for the removal of the boot/shoe. This tension system may include an automated or semi-automated catch/lock that would engage when the mold is manually pushed/moved into position for injection. This would securely hold the molding system in the aligned position through the injection procedure. Once cured the catch/lock would release the mold moving it slowly and forcefully to the horizontal position for boot/shoe removal.

Part 28 is the single mount mast for either mold mount. This mounting option uses two Masts per Mold Set or a single mast for each mold. The two masts are located in a group distinguishing them from other mast sets. A single mold is mounted to a single mast and has two opening options. The first is for the mold system to remain stationary, open and the Last to then rotate 90° to a horizontal position for boot/shoe removal. The second is for the entire or primary part of the mold to rotate 90° to the horizontal position for boot/shoe removal.

### DETAILED DESCRIPTION—FIGS. 15 TO 20

Part A is a typical high pressure injection molding machine. There are a number of high pressure injection molding machines on the market capable of using the various polyurethane formulas and other materials expected to be used with this molding table. gusmer, cannon and many others have been researched and with few exceptions can be used “off the shelf” or can easily be adapted for use with this molding table. The various machine setups include the use of “straight” and “I” configured Injection Heads. This molding table system requires a twin Injection Head which will need to be configured by each machine vender to meet certain specifications.

Part 1 is the control unit and interface. This component is the primary mechanical & computer control Interface between the injection molding machines and the linear mold table. This unit organizes the mechanical piping systems, control systems and wiring systems for connection to the supply hose arm Item 2. This unit includes the primary system computer and is the primary operating technician interface and is used or programming and control of nearly all facets of the molding table system. The unit includes an extended keyboard and large plasma screen and special applications. This primary system computer is typically networked directly the primary business computer and when used by a licensee, networked directly to the polywear business computer systems.

Part 1A is the system information signaling system. This item uses four color lights to signal that certain actions may; be taking place, need to take place or, will take place. Additionally, there is a five color light signal system with corresponding lcd screens to provide additional information when a specific light is activated. This device also has a full set of programmable audio signals which can be used in conjunction with the light signaling systems and/or independently to signal other messages.

Part 2 is the supply hose arm. This supply arm acts as a bridge and carries the supply hoses, piping, mechanical controls and wiring controls between the control unit & Interface and the actual molding table and individual molds. This option provides the most direct route and shortest distance between the injection molding machines and the molds.

Part 3 is the cleanout position. This position located at the end of the table and beginning of the injection cycle is used to clear the Injection nozzles and conduct any necessary cleaning of the injection head. This area includes a work area and tool/materials storage/organizing area.

Part 4 is the set/pair of molds mounted on individual masts. A set/pair of molds including right and left are mounted separately on individual mounting masts. individual mount mast are positioned in pairs to easily distinguish different sets/pairs.

Part 5 is the injection head guide system. This is a guide track running almost the entire length of the molding table. The guide system can use a variety of mechanical and software applications to accurately guide the injection head to select injection or cleanout points along the molding table. Precision alignment and smooth, efficient, quiet maintenance free operations are the goal of this component.

Part 6 is the dual piping system for compressed air and mold release spray. This is a simple piping system caring the liquid “mold release” material for use at each mold station. This piping system also provides a supply of compressed air for use at each mold station, piped from compressor.

Part 7 is the overhead lighting system. This is specified lighting designed for machine operations and should be considered additional lighting added to a specific work area. It is expected that general lighting other than this specified lighting will be of a standard and sufficient to address any other needs.

The specified lighting system calls for three 8 foot dual fluorescent fixtures with high intensity bulbs to be hung in positions to best illuminate the machine and work area.

Part 8 is the coiled hose mold release dispensing system. This is a simple dispensing system for spraying mold release on the interior mold surfaces and Last. The coiled hose hold the dispensing gun out of the work area when not in use and when used can extend several feet to provide easy use on any part of the mold system.

Part 9 is the coiled hose compressed air dispensing system. This is a simple dispensing system for spraying compressed air on the mold surfaces and last. The coiled hose hold the dispensing gun out of the work area when not in use and when used can extend several feet to provide easy use on any part of the mold system and molding table with the immediate area.

Part 10 is the mold mounted colored light signaling system. Each mold will have this four light system with; blue, red, yellow and red lights to signal specific information about the individual mold or signal the need to look at the Information system located on the control unit interface. These lights may signal that an injection is taking place, that curing is not complete, the mold is ready to be opened and the boot/shoe removed, etc. In addition to the single color a light may blink on and off at a specific rate to signal something else.

Part 11 is the exhaust system. The exhaust system duct runs the entire length of the molding table. It is designed to capture the mold release over spray and filter it out of the air. The system also has the ability to move air over the mold thus providing some cooling when needed.

Part 12 is the individual mold duct and grate. The ducts connect directly to the exhaust system. The individual mold grates are located directly under the mold where they can capture most of the mold release over spray. These grates may have controls to open and close them. These controls may be manual, semi-automatic or fully automatic. In addition to opening to collect mold release over spray the grates may open to pull air over the mold in a cooling action.

Part 13 is the twin/dual injector head. This is a custom configuration of two separate injection heads manufactured by the same or two different companies. The Injectors may have straight or “I” shaped heads. They may be combined and share certain material supply lines or function independently as part of a single twin/dual injector head design. The twin/dual injector head is held by the twin/dual injection head & tracking system Interface, part 18. This interface controls all of the actions of the injector head.

Part 14 is the mast for single mold mount. This mast is designed to mount a single right or left mold of a mold set/pair. Single mount mast are located in sets to distinguish pairs. The mast mounting process may allow the mold to open and the last to move 90 degrees to the boot/shoe removal horizontal position or the entire mold may move 90 degrees to the horizontal position for opening and to remove the boot/shoe.

Part 15 is the dual mount mast for mounting both molds of a pair. This mast uses a rotation system between the molds and the mast. The mast is located between the right and left mold and fastened to the molds using the rotation system mechanism. The molds can work independently of each other on the mast or in unison. Each mold has it's own set of signal lights and control systems via the dual mount mast. The molds are injected in the upright position and after curing the mold is rotated 90 degrees to the horizontal position for boot/shoe removal.

Part 16 is the injection hose floor protection system. All of the necessary supply hoses, controls and wiring needed between the control unit interface and the injection head, flexible tracking system Interface and general molding table are safely carried on the floor between the control unit and molding table.

Part 17 is the flexible tracking system for injection hoses and controls. This system functions with the Injection head guide system and connects the injection hose floor protection system, part 16 and the twin injection head and tracking system interface. The system uses a track and moves the hoses and controls in an organized manner with the injection head. This sophisticated system provides the smooth, precise movement of the supply lines and controls with the movement of the injection head.

Part 18 is the dual/twin injection head and tracking system interface. This interface connects the flexible tracking system with the injection head and injection head guide system. This Interface provides mechanical links, control links and wiring links as well as alignment and management functions

Part 19 is the lift system. This lift system may or may not be hydraulically operated but will provide the necessary lifting and lowering actions to facilitate the proper movement and alignment of the sole-plates and/or sole-plate bed section. Each mold may have an independent lift system and it's operations may be activated manually, semi-automatically or automatically and interface with the control unit interface.

### OPERATION—FIG. 1

For a initial licensing fee, sale of raw materials and a royalty on each pair manufactured, PolyWear will supply the Licensee with a comprehensive footwear manufacturing system and the technician to manage it's operation. This “Turnkey” type of business application is unique in the footwear industry. PolyWear will strategically identify successful footwear industry companies serving different markets around the world and solicit their participation in the Licensing Program. These companies will typically have strong existing; marketing programs, distribution channels and impressive sales of existing products. PolyWear will then introduce the PolyWear products and Patent Pending PolyWear Manufacturing System which enables the manufacturing of a superior product for only a fraction of competitors pricing.

One or more of the multiple patent pending components of the PolyWear Manufacturing System will provide a significantly cheaper method for manufacturing Footwear and Footwear Components. For instance the PolyWear Manufacturing System will produce a Polyurethane boot at a manufacturing cost competitive with PVC and Rubber boots of the same basic style and design. The industry and consumers agree that Polyurethane boots are for many reasons far superior to PVC and/or Rubber boots. Typically Polyurethane boots cost at least twice as much to manufacture as PVC and Rubber boots and retail for two to five times as much as comparable PVC and Rubber boots. Therefore, the ability to manufacture Polyurethane boots at a cost competitive with PVC and Rubber boots is a significant technological achievement. Furthermore, the ability to promote the sale of the far superior Polyurethane footwear and protective footwear will provide the opportunity for manufacturers to achieve high profits and for consumers to enjoy significant savings on a product that had been much more costly until this patent pending breakthrough in technology.

### OPERATIONS FIGS. 2 TO 14

This new Dual Rotating & Shuffling Sole-Plate Footwear Injection Molding System provides a much simpler, less expensive and higher production means to manufacture injection molded footwear and footwear components. The system will significantly reduce the initial costs for a molding system/equipment and setup in today's market. The system will also produce a significantly higher volume of products than current technology used for the manufacture of similar products. Using Polyurethane, the System can produce a product retailed for ½ or less than competitive products in the U.S. market.

The use of the Dual Rotating & Shuffling Sole-Plate technology can significantly reduce cost by substantially cutting production time. Likewise, the use of a Linear Footwear Molding Table with this molding system will further reduce manufacturing costs. The substantial savings derived from the equipment purchase and setup through to full operations, labor and raw materials will significantly impact the injected molded footwear industry. These systems should likewise impact the consumer with higher quality products at significantly lower retail pricing.

### OPERATIONS FIGS. 15 TO 20

The Linear Footwear Injection Molding Table is a complex system designed to be used with the Dual Rotating & Shuffling Sole-Plate Footwear Molding Systems to produce injection molded footwear. Typically, injection molding systems used in the footwear industry are circular with the injection head stationary with the molds traveling around the circle from station to station, procedure to procedure. Because curing time is an important factor it is difficult to stop the molding to make an adjustment or change a mold because this delay effects all of the molds.

On the Linear Molding Table the molds remain stationary while the injection head travels on a track moving from one mold to another. This system allows the process to skip a particular pair of molds without causing any significant effect on the other molds. This provides for the quick and easy changing of mold pairs or size changes and other necessary maintenance work that would require a'full system shutdown when using a circular molding system.

On the Linear Footwear Injection Molding Table is the interface for the Primary System Computer and all functions are either automated and/or semi-automated and/or manual. Complex programmed sequences provide optimum production while the comprehensive system monitors; raw materials, all equipment, technicians, attendants and just about everything in the production system. The Primary System Computer is also interfaced with the Primary Business Computer System via a network and/or the internet and/or satellite and/or telephone connection. This interface or network link provides for easier management of all system operations and facilitation of all logistics for the equipment.

The Linear Footwear Injection Molding Table may be used with molding systems using polyurethane, PVC and other materials formulated for use molding footwear and/or footwear parts.

### CONCLUSION, RAMIFICATIONS, AND SCOPE

Accordingly the reader will see that, according to the invention, I have provided it will be much easier and less costly to enter the footwear manufacturing industry or expand existing footwear manufacturing operations to include injected molded polyurethane footwear. This turnkey approach provides all the essential ingredients to operate a successful manufacturing business. The unique designs of both the mold with dual rotating or shuffling sole-plates and the linear molding table will in a number of ways reduce the cost of manufacturing while at the same time increasing the speed and efficiency by which the manufacturing takes place.

While the above description contains many specifications, these should not be construed as limitations on the scope of the invention, but as exemplifications of the presently preferred embodiments thereof. Many other ramifications and variations are possible within the teachings of the invention. For example, the mold allowing for simultaneous injection of two separate cavities with different materials may also be used to manufacture a pair of eye glass frames where the area holding the lens needs to be a harder material than the portion that rests on and behind the ear.

Thus the scope of the invention should be determined by the appended claims and their legal equivalents, and not by the examples given.

1. A business practice for the manufacture of injection molded polyurethane products such as footwear where an individual or company is licensed to use certain equipment, certain raw materials, and certain methods to produce the manufactured footwear—the improvement wherein the injection molding equipment

2. The business practice of claim 1 wherein said licensee is provided the necessary injection molding machine and equipment to produce the product.

3. The business practice of claim 1 wherein said licensee is provided the raw materials used in the injection molding machine to produce the product.

4. The business practice of claim 1 wherein said licensee is provided the molds used to produce the product.

5. The business practice of claim 1 wherein said licensee is provided a technician to administer the production of the product.

6. A business method for the manufacture of injection molded footwear comprising:
(a) providing the licensee the necessary injection molding machine and equipment to produce the product,
(b) providing the licensee the raw materials used in the injection molding machine to produce the product,
(c) providing the licensee the molds used to produce the product,
(d) providing the licensee a technician to administer the production of the product, whereby said business is provided the elements necessary to manufacture the injection molded footwear.

7. A single mold consisting of multiple parts which when arranged differently during the injection molding process produce a single finished product comprised of parts with different material compositions:

8. The mold in claim 6 wherein the mold may rotate on the mast of a molding table.

9. The mold in claim 6 wherein the injection of different materials into different ports, filling different cavities may take place at the same time.

10. The mold in claim 6 wherein a movable part of the mold used to form two identical molded parts may be injected at alternate times.

11. The mold in claim 6 wherein a movable part of the mold may be repositioned so upon the next injection series it is not injected

12. The mold in claim 6 wherein a movable part of the mold may be repositioned so upon the next injection series a different portion of the mold is injected with a material that joins to the previously injected material in the mold.

13. A multiple station linear molding table consisting of two or more molding stations comprised of dual mold attachments for molding pairs of footwear:

14. The multiple station linear molding table in claim 12 wherein individual molds may simultaneously be injected into two separate ports filling different cavities and forming different separated parts within the mold.

15. The multiple station linear molding table in claim 12 wherein two different materials may be injected into two different ports of the same mold at the same time.

16. The multiple station linear molding table in claim 12 wherein a dual injection head is used to inject multiple ports of the same mold with different materials simultaneously.

17. The multiple station linear molding table in claim 12 wherein a dual injection head moves linearly from one end of the table to the other.

18. The multiple station linear molding table in claim 12 wherein a mold may rotate on a mast.

19. The multiple station linear molding table in claim 12 where a wheeled cart may be used to position molds for mounting onto a mast.

20. A method of molding polyurethane footwear using a complex mold, comprising:
(a) place the mold in the upright position,
(b) using a dual injection head inject the lowest port of the outsole sole plate with a polyurethane material,
(c) allow the polyurethane material to cure,
(d) now move the sole plate containing the cured polyurethane material to position where it is contiguous with the upper/shaft portion of the mold,
(e) close and secure all moving parts of the mold,
(f) using a dual injection head simultaneously inject both the uppermost port on the mold filling the insole/shaft/upper with one polyurethane material and the lowest port on the mold filling the outsole sole plate with a different polyurethane material,
(g) allow the polyurethane materials to cure,
(h) disengage the soleplate portion of the mold from insole/shaft/upper portion of the mold,
(i) open the insole/shaft/upper portion of the mold and remove the finished footwear product from the last,
(j) prepare the mold before closing,
(k) move the previously injected outsole contained in the dual or rotating sole plate to a position contiguous with the insole/upper/shaft portion of the mold,
(l) continue dual injection process with moving dual sole plate until ready to complete injection of final item from the mold,
(m) move the previously injected outsole in the dual soleplate to a position contiguous with the insole/upper/shaft portion of the mold,
(n) using a dual injection head inject the port of the insole/shaft/upper portion of the mold with a polyurethane material to finished the last item being molded,
(o) allow the polyurethane material to cure,
(p) disengage the soleplate portion of the mold from insole/shaftupper portion of the mold,
(q) open the insole/shaft/upper portion of the mold and remove the finished footwear product from the last,
whereby a polyurethane footwear item constructed of two different materials is now complete.

21. The method of claim 18 wherein the two polyurethane materials injected from the dual injection head may consist of different formulas
